(19) United States
(12) Patent Application Publication
(10) Pub. No.: US 2011/0210004 A1
(43) Pub. Date: Sep. 1, 2011

(54) Boron-Doped Diamond

(76) Inventors: Patrick Unwin, Rugby (GB); Julie Macpherson, Coventry (GB); Mark Newton, Kenilworth (GB)

(21) Appl. No.: 13/063,795

(22) PCT Filed: Jan. 6, 2009
(86) PCT No.: PCT/GB2009/000017

§ 371 Date: May 10, 2011

(30) Foreign Application Priority Data
Sep. 12, 2008 (GB) 0816769.4

(51) Int. Cl. G01N 27/30; C25D 5/18; C25D 7/00; B82Y 99/00; B82Y 40/00

(52) U.S. Cl. 205/50; 205/105; 204/290.01; 204/431; 977/773; 977/890

(57) ABSTRACT

The invention relates to a method for preparing metal nanoparticle-modified boron-doped diamond the method comprising generating a strong oxidising agent by acid treating a front surface of the boron-doped diamond prior to deposition of the metal nanoparticles onto the front surface of the boron-doped diamond. The metal nanoparticle-modified boron-doped diamond resulting from the acid wash has a front surface which is oxygen terminated. The metal nanoparticle-modified boron-doped diamond may be used in electrodes as an oxygen sensor, the electrode may be made by preparing a boron-doped diamond column; insulating the column so that only a front surface of the column is exposed; polishing the front surface of the column; acid-treating the front surface of the column; and depositing metal nanoparticles onto the front surface of the column.

The invention relates to boron-doped diamond (BDD), in particular to metal nanoparticle-modified BDD, to electrodes including the modified BDD and to methods of producing these. The invention further relates to the use of these electrodes as oxygen sensors

The modification of BDD has been studied, for instance, Riedo et al. describe the preparation of platinum modified BDD and the analysis of these systems by cyclic voltammetry. However, the preparation of the BDD surfaces is not described and no particular applications of the platinum modified BDD are discussed.¹

The detection of dissolved oxygen (O₂), particularly in aqueous solutions, has been of great interest and study over the last fifty years due to its importance in environmental monitoring, industrial safety, fuel cell technology and the automotive industry.² Various dissolved oxygen sensors are available commercially including, for example, optical, polarographic and galvanic-based sensors.³ The most common dissolved oxygen sensor is based on the electrochemical Clark-type polarographic probe,⁴ in which a permselective membrane (most commonly poly-(tetrafluoroethylene)), separating an internal filling solution and the exterior solution, is used to detect oxygen amperometrically at a platinum (Pt) electrode. A potential is applied to the electrode to reduce oxygen and the current that flows is proportional to the concentration of oxygen present.⁵ These sensors have good detection limits and accuracy, but the use of a perm-selective membrane severely limits the response time. Furthermore, if the electrode becomes blocked, the reliability is compromised and so routine conditioning or membrane replacement is common.⁶

The mechanism for the electrochemical reduction of oxygen has been widely investigated for various electrode materials over a wide range of solution conditions. The mechanism is complicated and has been found to be dependent on solution pH, electrode material and size (mass transport rate).⁷ Two limiting reaction pathways have been identified: reduction of oxygen to hydrogen peroxide via a two-electron pathway^{8,9} and reduction of oxygen to water by a four-electron pathway.¹⁰

The reduction of oxygen at platinum is generally considered to occur via a four-electron process, as shown in equations 1 and 2, for acidic and alkaline solutions, respectively.¹¹

However, it has also been demonstrated that high rates of mass transport can lower the apparent number of electrons involved.^{12,13,14}

O₂+2H₂O+4e⁻→4OH⁻ (1)

O₂+4H⁺+4e⁻→2H₂O (2)

Polycrystalline boron doped diamond (pBDD) has been used as an electrode material. The very wide potential window in aqueous solution, low background currents and resistance to electrochemical fouling,^{15,16,17} make it suitable for use in electroanalysis. BDD is also resistant to corrosion under both acidic and alkaline conditions, as well as at extreme positive and negative potentials,¹⁸ and is stable at high temperatures and pressures.

BDD free from non diamond material kinetically retards the electrochemical reduction of oxygen, making it extremely difficult to electrochemically detect oxygen. For example, Yano et al.^{19,20} have shown that after cycling to +1.8 V vs. Ag/AgCl, in alkaline solution to remove/deactivate sp²-type carbon impurities, pBDD demonstrated relative insensitivity to oxygen reduction, in both acidic and basic media. Thus it is useful to enhance the sensitivity of pBDD to oxygen detection, whilst retaining as many as possible of the useful properties of the BDD. Various approaches have been investigated including functionalisation with metal nanoparticles such as gold^{21,22} and the application of quinone²³ and bismuth films.²⁴

In the case of gold functionalisation it was found that gold nanoparticles had an oxygen catalytic efficiency greater than that of polycrystalline gold, in both acidic and alkaline solutions. Yagi et al²⁵ reported that oxygen reduction occurred via a 4-electron pathway on vacuum-evaporated gold nanoclusters on pBDD films in acidic solution, which was also supported by the work of Szunerits et al.²⁶ for gold nanoparticles electrochemically reduced onto the surface of hydrogen terminated, oxygenated or aminated pBDD. Despite the growing body of work on the electrocatalytic reduction of oxygen at functionalised diamond surfaces, there has hitherto been little or no work exploring the capabilities of functionalised pBDD as a quantitative amperometric oxygen sensor.

Wang et al. carried out studies on platinum nanoparticles electrodeposited on hydrogen-terminated pBDD films, where the particles were anchored with a secondary intrinsic diamond layer, deposited post electrodeposition of Pt.²⁷ When using potentiodynamic deposition, platinum nanoparticles were found to deposit at grain boundaries. However, when galvanostatic deposition was used the entire diamond surface was decorated, with particle size ranging from 30 to 500 nm after second diamond film growth. A loss of activity in the platinum nanoparticles was observed after the second diamond growth. The Pt-pBDD electrode was seen to have a similar oxygen reduction response to that of clean platinum foil.

There is therefore a need for an electrode which provides for the detection of oxygen over a wide range of oxygen concentrations and pH values. In particular, there is a need for an electrode which can detect oxygen over a pH range including acidic and alkaline conditions.

According to a first aspect of the invention there is therefore provided a method for preparing metal nanoparticle-modified BDD comprising acid treating at least part of a front surface of the BDD to oxygenate the acid treated part of the BDD, in a step prior to a step of depositing the metal nanoparticles onto the front surface of the BDD. In general, substantially all, if not all, of the front surface of the BDD will be acid treated.

Prior to acid treatment the surfaces of the BDD are hydrogen terminated, and hence hydrophobic. This hydrophobic surface makes it difficult to adhere the metal nanoparticles to the surface of the BDD and has historically resulted in solutions such as that described in Wang et al. where the particles were anchored to hydrogen-terminated BDD surfaces with a secondary diamond layer which partially embedded the metal nanoparticles.²⁶ The application of further diamond layers is time consuming, costly and the secondary diamond layer can completely encase or reduce the surface area of the metal nanoparticles, preventing them from performing their oxygen detection function.

Acid washing the BDD surface prior to deposition of the metal nanoparticles substitutes at least some of the terminal hydrogen atoms for oxygen atoms, the oxygen terminated surface is hydrophilic and the metal nanoparticles adhere well to this surface. The term oxygen termination includes carbonyl termination (C═O), bridging oxygen termination (C—O—C), and hydroxy termination (C—OH) either alone or in combination. It is important that the acid washing oxidises the surface of the BDD, as such, the acid is typically a strong acid. Further, adherence of the metal nanoparticles is most efficient where the acid treatment is a separate step which occurs prior to deposition of the metal. Although some oxygen termination may occur where metal particle deposition is, for instance, through potentiometric cycling in a mild acid solution, substitution of the hydrogen atoms with oxygen atoms is achieved most efficiently where the acid treatment is a separate step and/or the acid is a strong acid.

Accordingly, as used herein the term “oxygenate” is intended to mean the modification of at least part of a BDD surface such that the modified part is oxygen terminated.

The metal nanoparticle-modified BDD prepared in this way is typically stable in that the nanoparticles remain on the surface for a time in the range 1 day-3 months, often 2 weeks-3 months, generally 1-3 months. Until now, many metal nanoparticle-modified BDD products were unstable, or stable for a shorter time than those observed with the metal nanoparticle-modified BDD of the invention. The ability to produce stable metal nanoparticle-modified BDD is just one of many advantages of the invention.

Accordingly, in a second aspect of the invention there is provided a metal nanoparticle-modified BDD obtainable by the method of the first aspect of the invention. A third aspect of the invention provides a platinum nanoparticle-modified boron-doped diamond for use in the detection of oxygen, the platinum nanoparticle-modified boron-doped diamond comprising an at least partly oxygen terminated front surface of the boron-doped diamond; wherein the platinum is electrodeposited onto the front surface of the boron-doped diamond.

A fourth aspect of the invention provides an electrode comprising a metal nanoparticle-modified BDD as defined in the second aspect of the invention and/or as prepared using the method of the first invention. The electrode including the metal nanoparticle-modified BDD of the invention is robust and resistant to corrosion and can be used across a wide pH range.

In a fifth aspect of the invention the electrode of the third aspect is manufactured, the steps comprising:
preparing a boron-doped diamond column;
acid-treating at least part of a front surface of the column to oxygenate the acid treated part of the BDD;
insulating the column; and
depositing metal nanoparticles onto the front surface of the column.

Manufacturing the electrode in this way provides a greater flexibility of electrode geometry than has been seen with earlier BDD electrodes. For example, known electrodes are typically prepared from a thin large surface area of diamond (>1 cm²), the electrochemically active area (the front surface) being selected by placement of an O-ring over the surface of the diamond. It is the electrochemically active area, which supports a cell containing the solution of interest. In a second step, the front surface is insulated with a suitable material to reduce the electrode area.

In many cases the BDD electrode of the invention will be a disc electrode and hence may be used with existing rotating disc electrode (RDE) electrochemical systems or impinging jet systems, without the need to specifically adapt these systems to accommodate the electrode of the invention. The electrode may also be attached to an apparatus to agitate it in a solution. However, the electrode may also be a band electrode for use in flow-through electrochemical detectors or a microelectrode.

Further, the inventive electrode offers near reversible peak potential separations at high concentrations of redox species, for example 10 mM Ru(NH₃)₆³⁺ at a 1 mm diameter disc BDD macroelectrode and works with a wide range of solvents (when compared to platinum metal electrodes) whilst retaining the reduced background current typically observed for BDD electrodes.

A sixth aspect of the invention relates to the use of the electrode of the fourth aspect of the invention to detect oxygen and a further aspect of the invention provides an oxygen sensor comprising the metal nanoparticle-modified BDD according to the second or third aspects of the invention.

The inventive oxygen sensor can be configured to show a linear response to oxygen concentration and may be able to detect oxygen concentrations at levels as low as ˜1 ppb or less in acidic, neutral and alkaline conditions.

In recent times, electrically conductive boron doped diamond produced by chemical vapour deposition (CVD) has become established as an electrode material. The electrically conductive diamond may be generated by any method known in the art, but are preferably produced by the addition of dopant element(s). Doping can be achieved by implantation, but is preferably achieved by incorporation of the dopant element during synthesis of the diamond, e.g. during synthesis of the diamond by chemical vapour deposition (CVD). The preferred method of making the CVD diamond electrically conductive is by the addition of boron during the synthesis process, although other dopants such as phosphorus or sulphur may also be used. BDD is known and the preparation of BDD would be understood by the person skilled in the art as requiring that sufficient boron be present in the diamond crystal to confer conductive properties on the crystal. When the conductive regions comprise boron doped CVD diamond, the boron concentration within the CVD diamond layer is typically between 1×10¹⁹-5×10²⁰ boron atoms cm⁻³. The boron concentration of a region of boron doped diamond can be measured using secondary ion mass spectroscopy (SIMS).

Preferably the dopant concentration is uniform through the conductive diamond surface used in the electrochemical application. In this context, the term “uniform” is intended to refer to the dispersion of dopant when viewed over the analysis surface a conducting BDD, such that measurements made from the device constructed from the BDD are not adversely influenced by the non-uniformity of the dopant density and the electrical conductivity. Further within the grains of BDD the concentrations of impurities other than boron should preferably be very much less than the concentration of boron and preferably at levels of no greater than 1 part per million carbon atoms.

It is well known in the art that the uptake of impurities or dopant element into a growing crystal such as CVD diamond can be sensitive to a number of factors. In particular, the uptake of dopant may be affected by the presence of other defects, such as dislocations or other impurities. In addition, the crystallographic face on which growth is taking place may also affect uptake of dopant. The common crystallographic faces in CVD diamond are the {100}, {110}, {111}, and {113} faces. The relative uptake of impurities in the growth sectors formed by these different faces is very different, and may also vary with growth conditions. For example, the {111} growth sector typically takes up somewhere between 10 and 30 times as much boron as the {100} growth sector. As a consequence of the differential uptake of boron between the different growth sectors, any CVD diamond which includes both the {111} and the {100} growth sectors, such as typical in pBDD CVD diamond, shows huge local variations in boron concentration.

The BDD is preferably free from inclusions of non diamond carbon (e.g. hydrogenated amorphous carbon, graphite, etc) or other non diamond material either at grain boundaries or in the bulk material.

In preferred embodiments where the conductive diamond comprises single crystal BDD, it is preferred that the device is fabricated from a single growth sector. Where possible the single crystal is of substantially homogenous composition, by which is meant that the boron is evenly distributed within the boron-doped diamond. It is preferred that the concentration of boron atoms in the single crystal diamond does not vary from the mean concentration measured by more than about 30%, preferably 20%, preferably 10%. The boron doped single crystal diamond may be prepared with a {100}, {110}, {111}, or {113} face, or with a face that is preferably within ±5° of one of these faces.

The resistivity of the BDD is preferably less than about 1 Ωcm (ohm centimeters), preferably less than about 0.5 Ωcm, preferably less than about 0.2 Ωcm.

In the subject invention the BDD may be prepared as a column; by column is meant any three dimensional shape which is generally longer along a single axis and substantially the same length across the remaining two axes. For two axes to be substantially the same length it is envisaged that their lengths be within 10% of each other and that the longer third axis be greater than 10% different in length. Often the third axis will have a greater than 20% or 50% difference in length. It is not necessary for a cross-section of the column to be of regular shape along the length of the column, although this will generally be the case. The column may, however, be of substantially square, cylindrical, rectangular or circular cross-section. The column may be prepared using laser cutting and a surface of this column comprises the acid-treated surface. For band electrodes, the column will typically be of rectangular cross-section.

The subject invention provides in one example a surface modified BDD, specifically a BDD which has an oxygen terminated surface by virtue of being acid washed. In general the acid is saturated with electrolyte, often the electrolyte will comprise potassium nitrate either alone or in combination with other electrolytes. The presence of potassium nitrate as an electrolyte provides a continuous supply of strong acid as the potassium nitrate reacts to form nitric acid.

This can be important where the acid and electrolyte mixture is being heated, and so the acid in solution is continually evaporating. As the acid evaporates the potassium nitrate is converted into nitric acid, ensuring no loss of acidic activity.

In the method for preparing the metal nanoparticle-modified BDD of the invention the acid typically comprises a strong acid, in particular an acid selected from sulfuric acid, nitric acid and perchloric acid, whether alone or in combination. Sulfuric acid is most often used, typically alone and generally as concentrated sulfuric acid. The concentrated acid may be a solution in the range 80-100%, often 90-100%, preferably 99% or greater. Often the solution will be an aqueous solution. Often the sulfuric acid is heated, heating may be to a temperature in the range of 200° C. to 340° C., in some instances the sulfuric acid will be boiling. In some cases the front surface of the BDD is treated with hot (often boiling) concentrated sulfuric acid supersaturated with potassium nitrate. The use of strong acid is intended to generate a very strong oxidising agent, the use of a strong oxidising agent oxidises the surface without roughening. Whilst other methods of oxidising the surface of BDD are known, they can roughen the surface of the BDD during the oxidising process, this is generally undesirable.

After acid treating and (where necessary) cooling of the acid solution, the front surface of the BDD may be rinsed, often rinsing will be with water. It is envisaged that the acid treatment step of the invention will generally be a separate step to deposition of the metal, to polishing of the BDD or any other electrode preparation step.

It is generally envisaged that the deposition will be at least partly electrochemical, often completely (i.e. electrodeposition); however other methods may be used. In many cases deposition will be chronoamperometric, and the optimal potential for chronoamperometric deposition has been found to be in the range −0.7 or −0.8 to −1.0 V, or in the range −0.9 to 1.0 V relative to a saturated calomel electrode. A potential of about −1.0 V (for instance −1.0 V±0.05 V) is most often employed.

Multi-potential step techniques for electrodeposition are also possible. In these techniques the electrode potential is stepped to several values to control the number density and size of the particles. Often the potential will be stepped to a large potential (−1.0 V) for a brief period (1-10 ms) to create nuclei and then to a lower driving force (for instance in the range −0.6 to −0.9 V) to facilitate slow particle growth while minimizing the deposition of further nuclei.

In most preparation methods deposition occurs over a period in the range 0.1 to 60 seconds, alternatively 1 to 20 seconds, often over a period in the range 5 to 10 seconds.

Where deposition is not electrochemical, chemical deposition (for instance deposition of a metal salt onto the BDD surface followed by reduction in, for example, a hydrogen stream) or other known techniques may also be used. Although deposition is likely to be electrochemical for polycrystalline BDD, single crystal BDD may undergo any of the above types of deposition.

In general, the metal nanoparticle-modified BDD of the invention will have a hydrophilic front surface. It is possible to determine whether the surface is hydrophilic by measuring the water contact angle (or contact angle with other solvents). On a hydrophobic surface (such as a hydrogen terminated surface) the water droplets will form spheres, on a hydrophilic surface (such as an oxygen terminated surface) the water will form a thin film.

At least part of the front surface of the BDD column (the surface of the BDD onto which the metal nanoparticles will be deposited) will typically be polished, although often prior to assembly of the electrode and insulation. Generally, substantially all of the front surface, if not all of the front surface, will be polished. It is this polishing which provides the smooth surface onto which the metal nanoparticles will be deposited. As it is generally preferable that acid treatment is applied to the final surface onto which the metal nanoparticles will be deposited, acid treatment generally occurs after the polishing step. In most instances the acid treatment will be a separate step which occurs prior to deposition; most often the acid treatment step will occur directly after the polishing of the front surface of the BDD column.

Typical roughness values for the front surface of the BDD of the invention would be in the range 1-20 nm, for some applications in the range 1-5 nm, often in the range 1-2 nm. The front surface may be polished to achieve this level of smoothness, where polycrystalline BDD is used polishing is particularly advantageous. However, polishing is not essential. It is desirable to have a very smooth front surface on the BDD as this provides better adherence of the metal nanoparticles to the surface and a more even distribution. Polycrystalline BDD will be polished in most examples to smooth the initially rough surface arising from the presence of more than one edge of a crystal face. Single crystals can be polished but this is not essential.

The deposition of metal nanoparticles onto the front surface of the BDD as opposed to particles or a solid coverage is beneficial as less metal is used; this has positive cost implications. In addition the use of nanoparticles offers increased diffusion rates relative to conventional metal electrodes (for instance Pt electrodes) and background effects are minimised.

In some examples the metal nanoparticle-modified BDD will be further treated by coating with a film. Coating may be using any of the techniques known in the art, including but not limited to spray coating, spin coating, dip coating, or in-situ polymerisation. In many embodiments the film will be an at least partially gas permeable film. The film may be of a polymeric material, and may aid in the selective discrimination of oxygen at the electrode. In an aspect of the selective discrimination the film prevents species other than oxygen contacting the metal nanoparticle-modified BDD and interfering with the electrochemical signal. As a result, the signal produced can be more accurately used to calibrate for not only the detection of oxygen per se but also for the sensing of oxygen concentration. The polymeric material may, in some instances, comprise a tetrafluoroethylene-perfluoro-3,6-dioxa-4-methyl-7-octenesulfonic acid copolymer (such as Nafion).

It will often be the case that the metal will comprise a metal selected from: platinum, palladium, gold and combinations thereof. Often the metal will consist essentially of these three metals (either alone or in combination), or even consist of one or more of platinum, palladium and/or gold. Platinum is however most often used as this metal is highly specific for the detection of oxygen.

The BDD used (for instance the BDD column) may be polycrystalline or a single crystal. Polycrystalline BDD is readily available, however, the different crystals in the polycrystalline diamond can take up boron differently and therefore offer different conductivity and interaction with the metal nanoparticles. For this reason, it may be desirable to use single crystal BDD as this may be more stable and offer a greater reproducibility of physical properties from electrode to electrode.

Therefore, according to a further aspect of the invention there is provided a single crystal metal nanoparticle-modified BDD. This is preferably as defined above.

It is not essential that single crystal metal nanoparticle-modified BDD's have an oxygen terminated or other hydrophilic front surface, although for the reasons described above this will generally be the case. Specifically, the surface of a single crystal BDD may be hydrophobic or hydrophilic and terminated with functionalities such as hydrogen atoms, oxygen atoms, hydroxyl groups, amine functionalities and combinations thereof. However, generally single crystal BDD will have a hydrophilic surface, which is oxygen terminated. Further single crystal metal nanoparticle-modified BDD's may be polished or unpolished (although generally they will be polished), used with a wide variety of metal nanoparticles which have been deposited in a range of different ways including electrochemical and chemical deposition.

The particles used in known nanoparticle-BDD electrodes have generally been of size in the range 10-500 nm. The nanoparticles deposited onto the BDD of the invention will typically be of size in the range 0.5-10 nm, often 0.5-5 nm, on occasion 0.5-1.5 nm. This is smaller than the particulate size obtained with earlier electrodes and less metal is therefore needed in order to provide a sufficient distribution of metal across the BDD. By sufficient distribution is meant a sufficient density of nanoparticles to provide some diffusional overlap between neighbouring nanoparticles on the timescale of the measurements. Diffusional overlap can be beneficial as nanoparticles arranged in this way will result in an electrode that behaves like a conventional macroelectrode, when detecting oxygen or other chemical species by amperometry and voltammetry. It can be desirable to have diffusional overlap between nanoparticles across the surface in the range of 50-100% of the front surface of the electrode, often 70-100% or 90-100%.

Typically, the metal nanoparticles described herein are substantially randomly distributed across the front surface of the BDD. The particle surface density of the metal nanoparticle-modified BDD may be such that diffusional overlap will be observed between neighbouring particles on the timescale of electroanalytical measurement. This particle surface density may be in the range 0.1-5000 often 50-500, sometimes 100-400 metal nanoparticles per μm⁻².

Alternatively, for some applications diffusional overlap may be undesirable. The particle density is thus reduced to a level where the time for diffusional communication between neighbouring particles (of the order of d/D^{1/2}, where d is the inter-particle half-spacing and D is the diffusion coefficient of the solute being analysed) is much greater than the characteristic measurement time. For a typical characteristic measurement time of 1-5 seconds in the detection of oxygen (D˜2×10⁻⁵ cm² s⁻¹) the particle surface density is reduced to a level in the range of 0.01-0.5 nanoparticles per μm⁻².

The metal nanoparticle-modified BDD of the invention is intended for use in an electrode, typically a disc electrode in which the disc is formed from the metal nanoparticle-modified BDD and is of diameter in the range 100 nm-2 mm, often in the range 0.1-1 mm. Much of the previous work on BDD has been carried out on large area electrodes (e.g. 5 mm×5 mm); however, the subject invention uses laser micromachining to miniaturise the existing technology and allow the fabrication of well-defined macroelectrodes in the 1 mm diameter range; such electrodes can be used as sensors.

Alternatively, where the metal nanoparticle-modified BDD is a band electrode, the band will be substantially rectangular and of size in the range 100 nm-2 cm on each side. Band electrodes are often used in flow systems, such as channel electrodes.

The metal nanoparticle-modified electrode may also be a microelectrode. Microelectrodes are useful in applications where sample volume is limited (microelectrodes are typically of electrode diameter in the range 50 μm or less) and where capacitive charging is distorting the results obtained using macroelectrodes or where it is preferable to avoid the use of a background electrolyte in solution. Further, microelectrodes can be used for solutions where the substance being studied (such as the oxygen) is unstable in solution as the sweep rate can be increased relative to macroelectrodes.

As with many electrodes, the metal nanoparticle-modified BDD will typically be at least partly insulated. The insulator will typically comprise an insulator selected from: glass, PTFE, polypropylene, porcelain, polyethylene, PVC, silicone, ethylene tetrafluoroethylene, epoxy resin or combinations thereof. Glass, PTFE and combinations thereof are typically envisaged, whether alone or in combination with other insulating materials.

Insulation of the metal nanoparticle modified BDD should be at least partial, however, at least a surface of the BDD should remain exposed to perform its electrochemical function. Typically this will be a “front” surface.

As used herein the term “surface” (including the “front surface”) is intended to mean not only a single face of the BDD but a “region” or “area” which is performing a particular function or which is being treated in a particular way. As such, although it will generally be the case that a surface, in particular the front surface, will be a face, generally a planar face of the BDD, it may also be, for instance, a protruding region, or a region within a face.

Further, the term “front” as used herein is not intended to limit the spatial positioning of the “front surface”. The use of the term “front” is merely indicative of the surface onto which the metal nanoparticles are deposited.

In many instances the electrode is assembled and the BDD column insulated prior to deposition of the metal nanoparticles. Accordingly, the front surface of the BDD column may be prepared for deposition after the electrode has been assembled. In many instances, the electrode is assembled such that only the front surface of the BDD column will be exposed after insulation. This may include examples where the column protrudes slightly beyond the insulation, for instance by 1 mm or less.

Where electrode assembly occurs prior to deposition of the metal nanoparticles, as will typically be the case, BDD insulation may be followed by removal of the insulator by polishing to expose the front surface of the BDD column. Deposition of the metal nanoparticles may proceed as described above. This method may be used for a variety of insulators, including glass. Alternative methods may also be used to encapsulate the BDD column, as would be known to the person skilled in the art.

In some examples the surface may be modified after deposition of the nanoparticles by techniques known in the art including surface etching or ultrasound redox. Such modification may partially remove the nanoparticles from the surface creating an area of metal nanoparticle modified boron-doped diamond of known dimensions. Alternatively, patterns may be etched in the diamond surface as would be known to the person skilled in the art.

The electrode of the invention is desirably stable for use across a wide range of pH values, including acidic and alkaline conditions. For instance, in many examples the electrode of the invention will be stable to, and able to detect a variety of species including oxygen across, a pH range 0-14. In some embodiments the electrode will be used for detection in narrower pH ranges, this may allow stability of the electrode across a narrower range, but use in these narrower pH ranges will not typically be indicative of a narrower range of electrode stability, merely of use for detection in a narrower window. Often the electrode of the invention will be used to detect species in the pH range 0-14, often 3-11, in some examples 4-10.

The electrode of the invention may be used as a sensor, in particular a sensor for molecular oxygen (O₂); generally for the detection of oxygen in solution, often the oxygen will be in aqueous solution.

Detection may be by any electrochemical means including sweep techniques (such as cyclic voltammetry) and amperometry. Amperometric techniques are often used as detection using amperometry is faster than sweep techniques. Where amperometry is used, the oxygen containing solution may be a quiescent or flow solution.

Unless otherwise stated each of the integers described in the invention may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims.

Unless otherwise indicated all percentages appearing in the specification are percentages by weight of the element being described. In addition, unless otherwise stated, all numerical values appearing in this application are to be understood as being modified by the term “about”.

### EXAMPLES

In order that the invention may be more readily understood, it will be described by way of example only, by reference to the accompanying figures, of which:

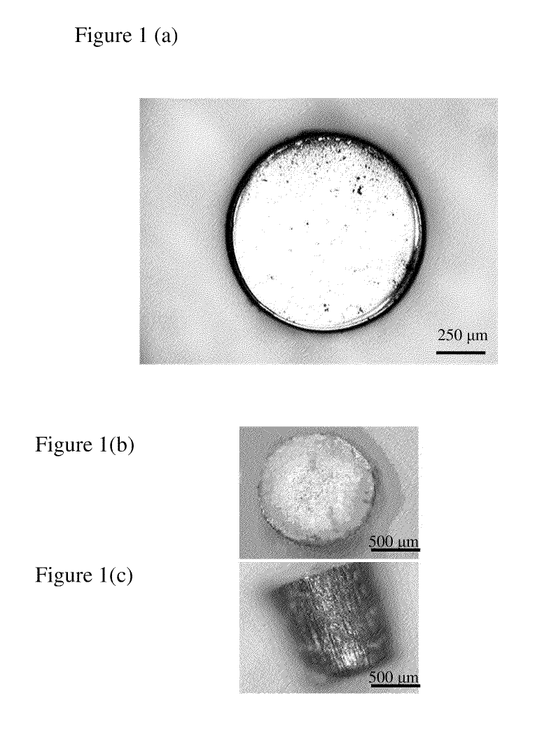

FIG. 1 is a series of optical microscope images of laser micromachined BDD column polished surface with (a) a 0.5 mm radius, (b) Ti/Au coated surface and (c) side view of 0.5 mm long BDD column.

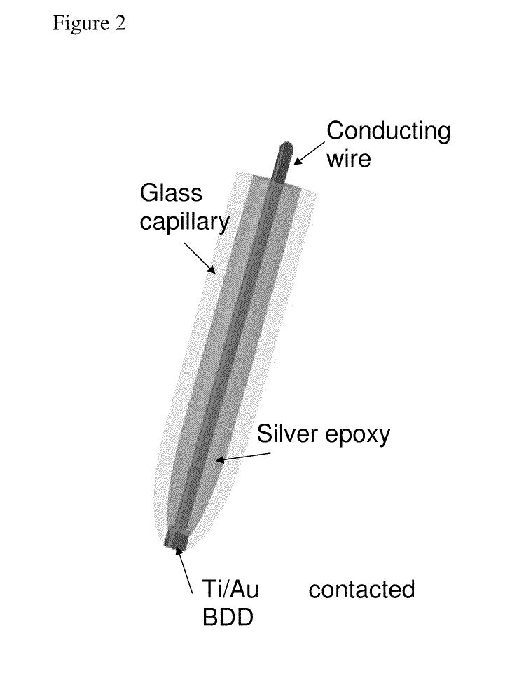

FIG. 2: is a schematic representation of a metal nanoparticle BDD electrode according to the invention.

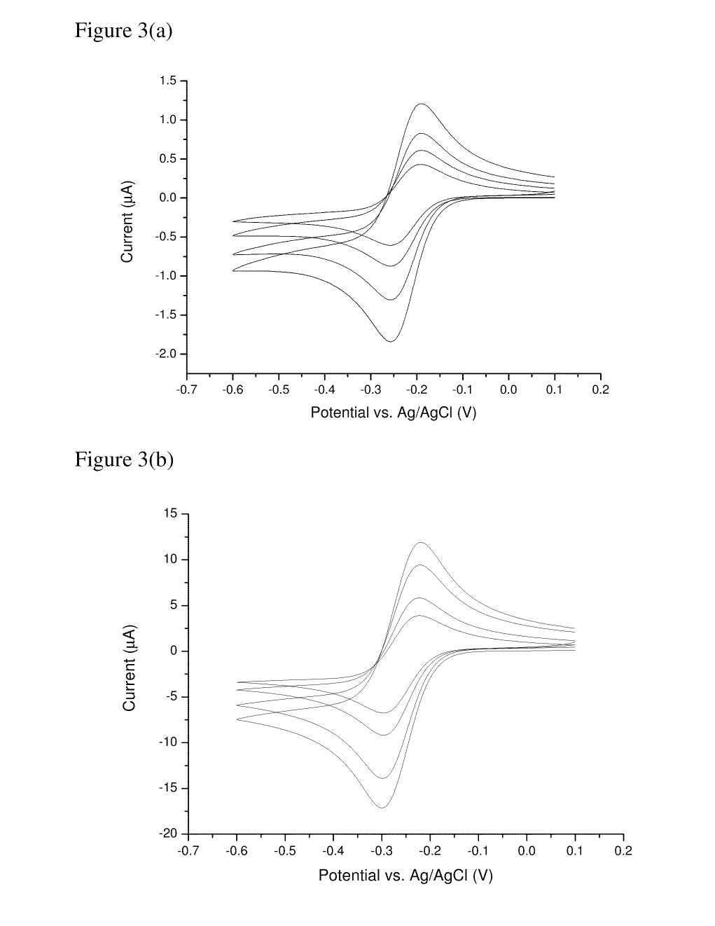

FIGS. 3(a) and (b) are cyclic voltammograms for the reduction of a) 1 mM Ru(NH₃)₆³⁺ and b) 10 mM Ru(NH₃)₆³⁺ in 0.1 M KCl at a BDD electrode, at scan rates 100 (highest peak current), 50, 20 and 10 (lowest peak current) mV s⁻¹

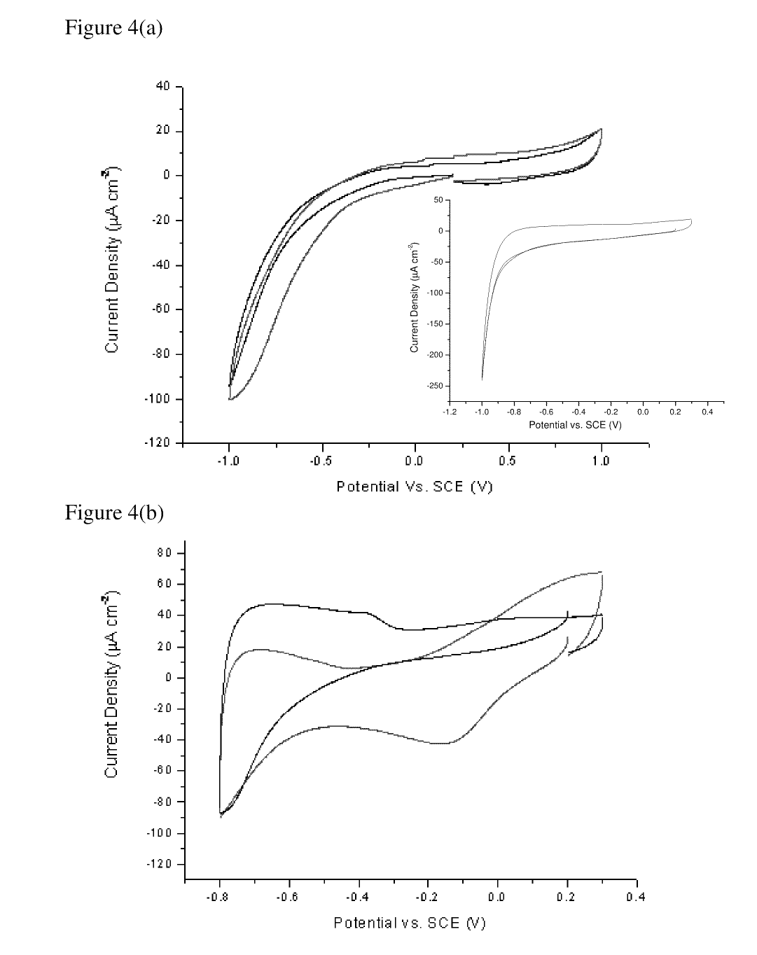

FIGS. 4(a) and (b) are cyclic voltammograms for (a) pBDD (with unlasered pBDD as inset) and (b) platinum, in nitrogen-saturated (black; no peak at around −0.175 V) and aerated (grey; peak at around −0.175 V) 0.1 M KNO₃ at a scan rate of 100 mV s⁻¹.

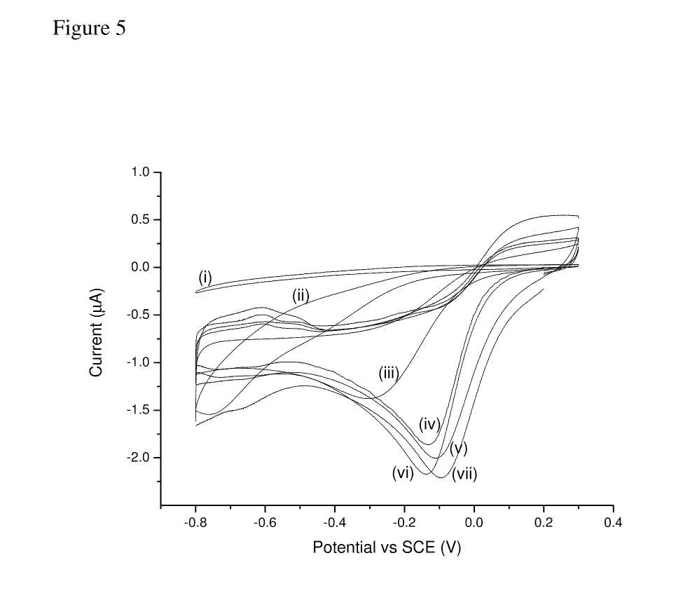

FIGS. 5 is a cyclic voltammogram for the reduction of oxygen in 0.1 M KNO₃ with a scan rate of 50 m V s⁻¹, at a Pt NP-modified BDD electrode where the Pt NPs were deposited at −1.0 V for 0 s (i), 0.1 s (ii), 0.25 s (iii), 0.50 s (iv), 1 s (v), 5 s (vi), and 30 s (vii).

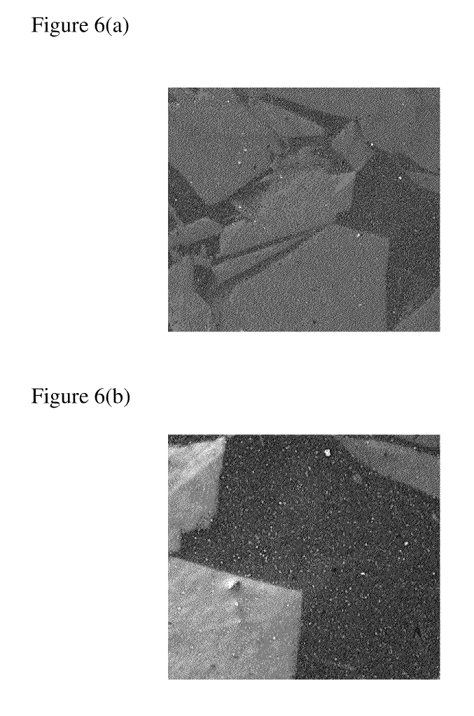

FIGS. 6(a) and (b) are FE-SEM images of a Pt NP-modified BDD electrode, with Pt deposition parameters of −1.0 V for 5 s at low resolution and higher resolution.

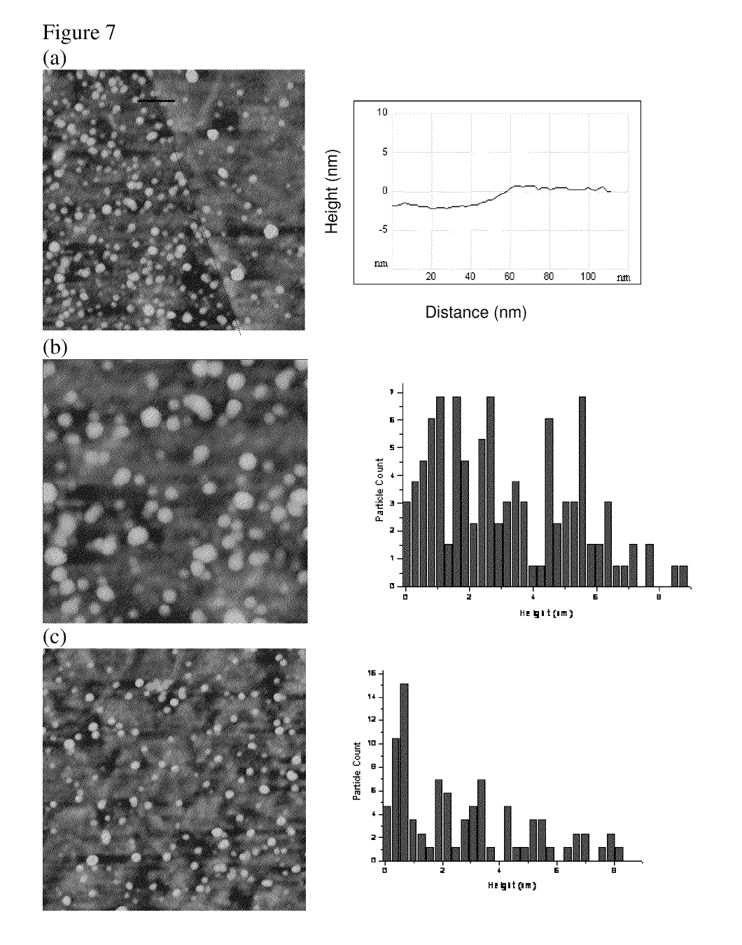

FIGS. 7(a) to (c) are AFM (tapping) images of Pt NPs deposited onto pBDD electrode at −1.0 V for 5 s on a) different grains with a plot of cross sectional height, b) to the right of the grain boundary with histogram showing particle height distribution, c) to the left of the grain boundary with histogram showing particle height distribution.

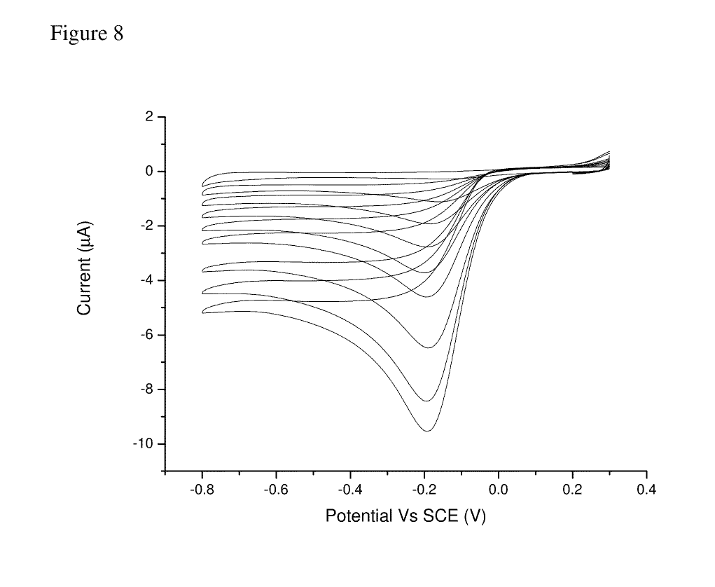

FIG. 8 is a cyclic voltammogram for the reduction of oxygen in 0.1 M KNO₃ and H₂SO₄ (pH 4) at a Pt NP-modified pBDD electrode, at percentages of oxygen in total gas flow of 0 (smallest peak current), 10, 20, 30, 40, 50, 70, 90 and 100% (largest peak current). Inset shows plot of background correct peak current against dissolved oxygen concentration.

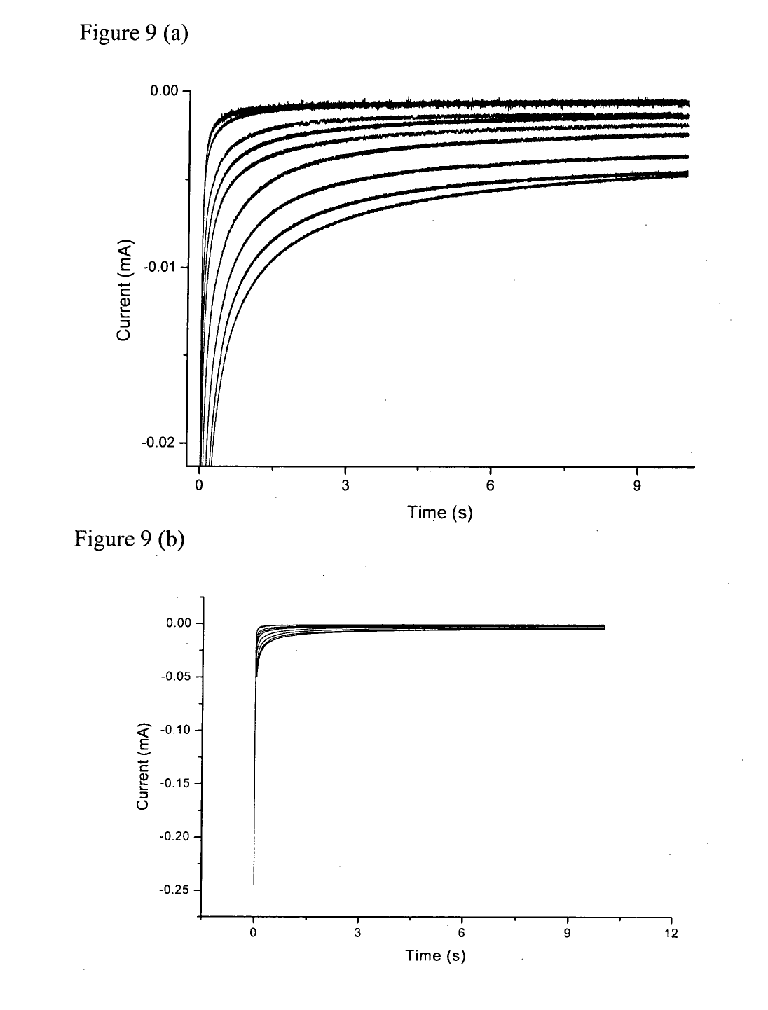

FIGS. 9(a) and (b) are chronoamperometric readings for the oxygen reduction in 0.1 M KNO₃ and H₂SO₄ (pH 4) at the Pt NP-modified pBDD electrode, at percentages of oxygen in total gas flow of 0 (the top current), 10, 20, 30, 40, 50, 70, 90 and 100% (the bottom current). The insert shows the full scale data. b) Chronoamperometric current plotted against time^{-1/2} for 0.1 M KNO₃ solution with a 30% oxygen flow rate for (i) pH 4, (ii) pH 5.5, (iii) pH 7.5 and (iv) pH 10.

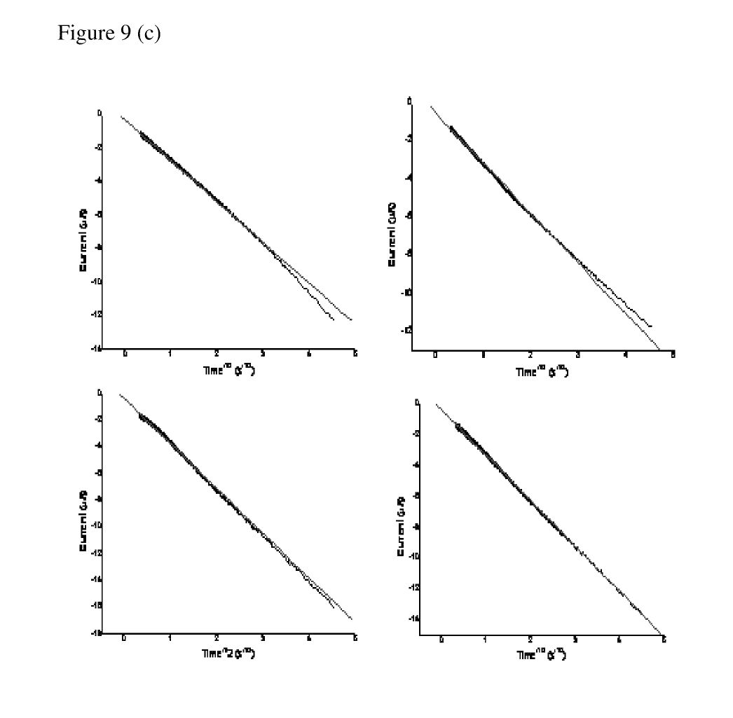

FIG. 10 is a chronoamperometric gradient plotted against the dissolved oxygen concentration in 0.1 M KNO₃ solution for (□) pH 4 (∘) pH 5.5 (Δ) pH 7.5 and (∇) pH 10.

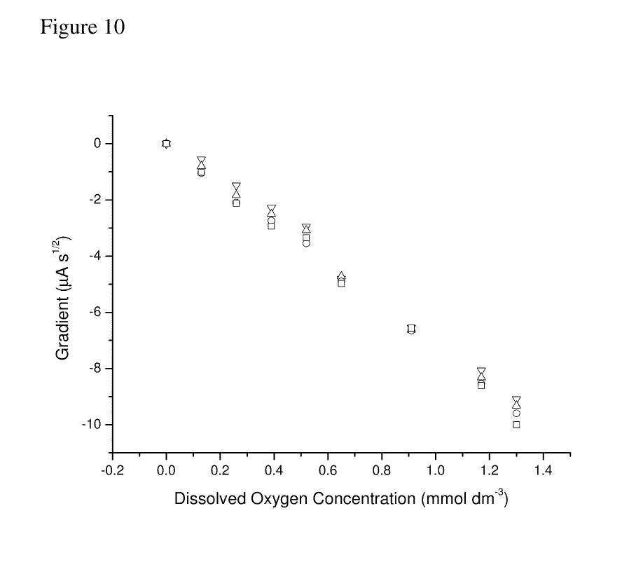

FIG. 11 is a chronoamperometric gradient of the current taken at 3 s recorded every hour for 12 hours in 0.1 M KNO₃ (pH 5.5) at the Pt NP-modified BDD electrode at 40% oxygen in total gas flow.

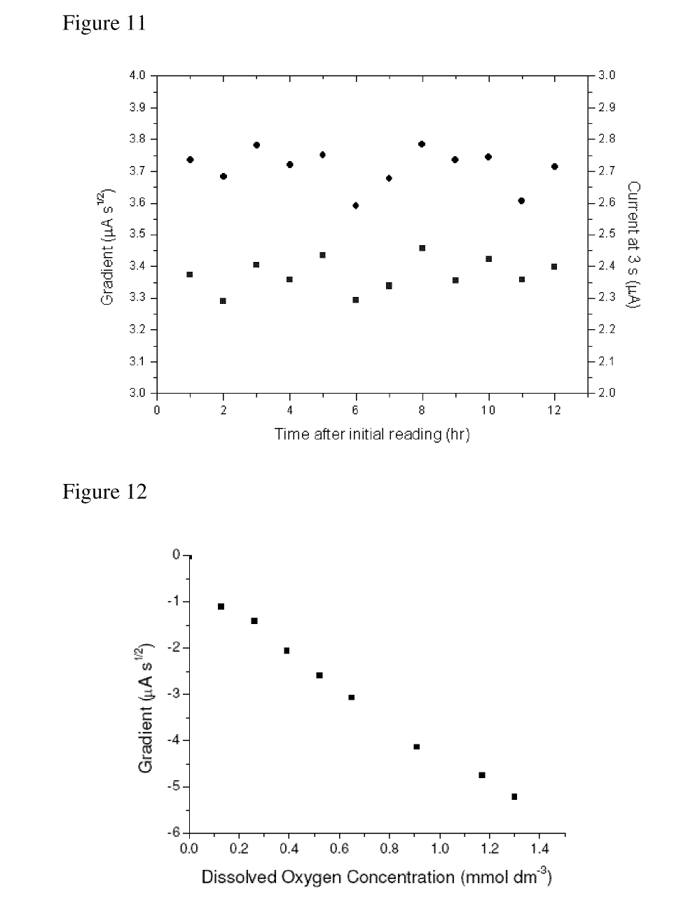

FIG. 12 is a chronoamperometric gradient plotted against the dissolved oxygen concentration in 0.1 M KCl solution (pH 5.6).

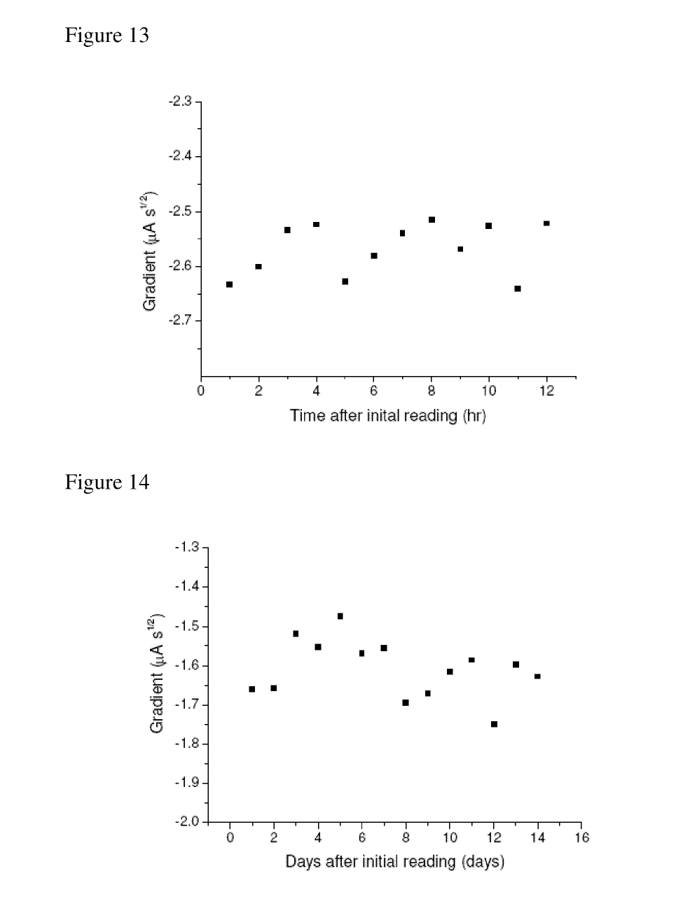

FIG. 13 is a chronoamperometric gradient of the current recorded every hour for 12 hours in 0.1 M KCl solution (pH 5.6) at 40% oxygen.

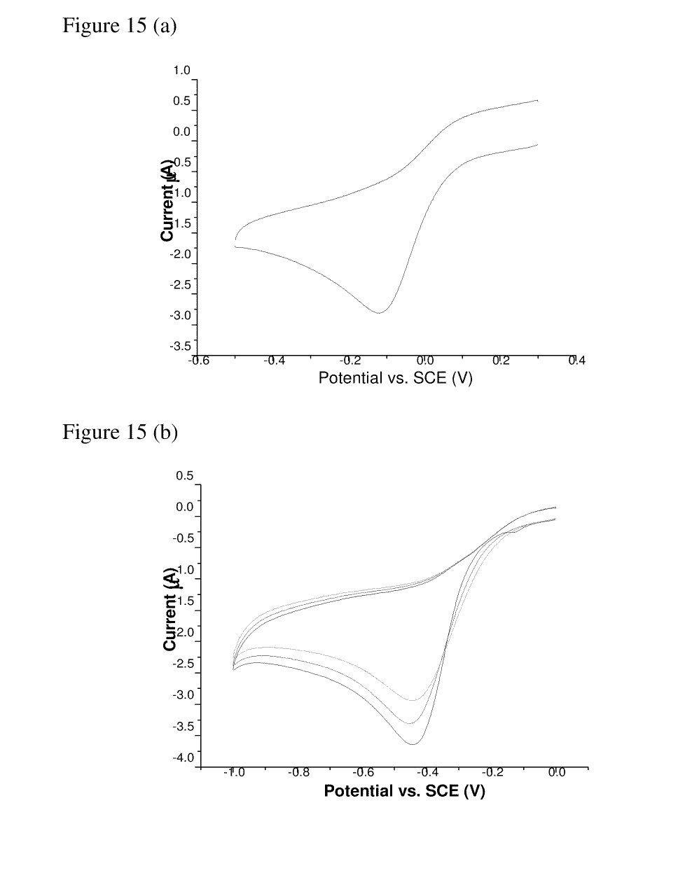

FIG. 14 is a chronoamperometric gradient of the current recorded every day for two weeks in 0.1 M KNO₃ (pH 5.5) at a Pt NP-modified BDD electrode under aerated conditions.

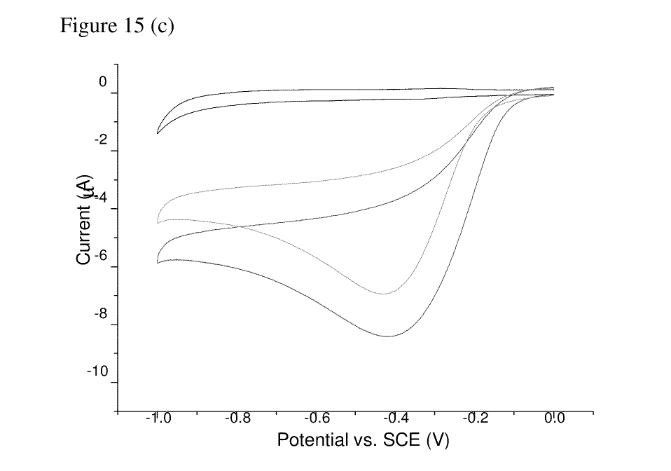

FIGS. 15(a)-(c) are cyclic voltammograms for the reduction of oxygen in 0.1 M KNO₃ at a Pt NP-modified pBDD electrode which is uncoated (a), coated with 10 layers of Nafion (b) and coated with 50 layers of Nafion (c).

### METHODOLOGY

### Solutions and Materials

All solutions were prepared from Milli-Q water (Millipore Corp.), resistivity 18.2 MΩ cm at 25° C. To test the electrochemical characteristics of the pBDD macrodisc electrodes prepared in-house, solutions comprising Ru(NH₃)₆³⁺ (obtained as the chloride salt; Strem Chemicals, Newbury Port, Mass.) at 1 mM and 10 mM concentration were employed (0.1 M potassium chloride supporting electrolyte). For the oxygen detection experiments, solutions comprised 0.1 M potassium nitrate (Fisher Scientific) with laboratory reagent grade H₂SO₄ (Fisher Scientific), or analytical grade potassium hydroxide (Fisher Scientific) added to obtain solution pH values of 4, 7.5 and 10. The oxygen concentration in solution was controlled by varying the ratio of oxygen (BOC, 99.5% purity) and nitrogen (BOC 99.9% purity) used to gasify the solutions.

The pBDD samples were prepared by Element Six Ltd. (E6 Ltd., Ascot, UK) using commercial microwave plasma CVD process, developed in-house. The average boron doping level of this material can range up to about 5×10²⁰ atoms cm⁻³, as determined by secondary ion mass spectroscopy (SIMS).²⁸ The pBDD samples were cut and polished by E6 to give a 500 μm thick sample with a surface roughness of ca. 2-5 nm as measured by atomic force microscopy (AFM).²⁸

pBDD Disk Electrode Fabrication

In order to fabricate BDD disk electrodes with well-defined dimensions, a laser micromachiner (E-355H-3-ATHI-O system, Oxford Lasers) was used to cut 1 mm diameter BDD columns (500 μm thick) from the samples provided. Cutting through a thick diamond sample required several passes with the laser given that the typical material removal depth is approximately a few microns per pass. In principle, this can make the attainment of a smooth and precise cut difficult, as the laser may reflect or absorb onto the walls of the recess producing curvature in the cut geometry. Laser kerfing was therefore incorporated into the program to minimise these effects. This is a technique where a series of cuts of a certain depth either side of an axis are used to remove a section of diamond. Typical cut sections of pBDD are shown in FIG. 1. Prior to further preparation, the pBDD columns were acid cleaned in hot concentrated sulfuric acid (98%), supersaturated with potassium nitrate. The solution was heated until it was just boiling and the potassium nitrate had been exhausted (fumes given off turned from brown to white). Once the solution had cooled, the samples were removed, rinsed repeatedly in water and allowed to dry in air.

In order to utilise the conducting diamond as an electrode, a reliable ohmic connection²⁹ was made to the back of the BDD columns by sputtering (Edwards E606 sputter/evaporator) a layer of titanium, followed by gold, with thicknesses of 10 nm and 1 μm respectively. The samples were then placed in a tube furnace at 500° C. for 4 h to anneal the contacts. Upon annealing the titanium forms a carbide-based tunnelling contact between the diamond and titanium carbide through which carriers can tunnel, lowering the contact resistivity to less than 1 Ω cm. The gold top contact serves as a highly conductive antioxidation layer. A similar method to the standard procedures for sealing metal wires in glass for the production of other types of electrodes was adopted in order to insulate the pBDD columns so that only the top (disk) surface was exposed.³⁰ After sealing in a pulled glass capillary (o.d. 2 mm, i.d. 1.16 mm, Harvard Apparatus Ltd, Kent, UK) the pBDD surface was exposed by polishing with carbimet grit paper discs (Buehler, Germany). Electrical contact was made to the pBDDlAu surface using silver epoxy (RS Components Ltd, Northants, UK) and a tinned copper wire used to form an external electrical contact Finally, epoxy resin (Araldite, Bostik Findley, UK) was placed around the top of the capillary to stabilize the copper wire. FIG. 2 shows a schematic of a final pBDD disk macroelectrode.

### Electrochemical Measurements

All electrochemical measurements using the pBDD electrodes were made in a three-electrode mode using a potentiostat (CHI730A, CH Instruments Inc. TX) connected to a laptop computer. Either a silver-silver chloride electrode (Ag/AgCl) or a saturated calomel electrode (SCE) was used as a reference electrode with a Pt gauze serving as a counter electrode. A 3 mm platinum disc electrode (CHI102, CH Instruments Inc) was used for comparison with the pBDD. The laboratory was air conditioned to 294±1 K. For experiments on oxygen detection, the dissolved oxygen concentration in the solution was controlled using oxygen and nitrogen gas mixtures to gasify the solution. Different ratios of oxygen to nitrogen were flown into the solution for ca. 30 mins, with the ratios accurately controlled using mass flow controllers (MKS Instruments) linked to a four channel power supply and display. The total gas flow rate was 35 sccm, while the ratio of oxygen to nitrogen was varied.

### Platinum Nanoparticle Deposition and Characterisation

The pBDD electrode was functionalised with platinum particles by applying a potential of −1.0 V (versus a saturated calomel electrode (SCE)) in a solution of 1 mM potassium platinum (IV) hexachloride (K₂PtCl₆) and 0.1 M hydrochloric acid, for various time periods in the range 1 ms to 30 s. The electrode was then rinsed with ultrapure water. For high resolution characterisation studies, using field-emission scanning electron microscopy (FE-SEM) and atomic force microscopy (AFM), it was necessary to prepare the electrode in a slightly different way to allow subsequent imaging the surfaces. The pBDD columns were fabricated as above and annealed to a flat quartz disk which had also been sputtered with a titanium/gold contact. A conducting wire was adhered to the gold contact of the quartz using silver epoxy.

Epoxy resin was used to seal around the edges of the pBDD column and the quartz, so that only the 1 mm diameter pBDD disk was uninsulated. FE-SEM images were recorded using an In-Lens detector at 15 kV (Zeiss Supra55VP). This lens allowed the grain morphology and platinum nanoparticles to be imaged at the same time. AFM images were recorded in tapping mode in order to minimise distortion or possible dragging of the nanoparticles (Vecco Enviroscope AFM with Nanoscope IIIa controller).

### Platinum Nanoparticle Optimisation

To improve the sensitivity of pBDD towards amperometric oxygen detection, while retaining the low background currents inherent with pBDD electrodes (aiding low concentration detection), the platinum coating of the surface was optimised. Such optimisation was to minimise the background current processes arising from the platinum particles, which scale with surface area, whilst obtaining a well-defined and quantitative oxygen signal. Platinum was electrodeposited onto the BDD electrode surface using chronoamperometry in a quiescent solution containing 1 mM K₂PtCl₆ in 0.1 M hydrochloric acid solution. Different deposition potentials and times were investigated in order to elucidate the effect on platinum particle size and density on the magnitude and shape of the oxygen reduction peak. Potentials more negative than −1.0 V gave noisy signals due to concomitant reduction of H⁺ to H₂ at the deposited Pt.³¹ −1.0 V was therefore the most driving potential that could be applied without detrimental effects of hydrogen (H₂) evolution.

FIG. 4 shows the effect of deposition time for a fixed potential (−1.0 V) on the oxygen response for deposition times in the range 0.1 to 60 s. Comparing the cyclic voltammograms for a 0.1 s deposition time with the background, it can be seen that a significant broad voltammetric feature appears with platinum on the surface, though the reduction-process is highly irreversible. Indeed, the inflexion in the current-voltage characteristic at approximately −0.5 V suggests the reduction may occur as a 2 electron process at low overpotential followed by a 2 electron process at higher overpotential.

As the platinum deposition time increased, a well-defined peak current developed, which is characteristic of planar diffusion. This moved to increasingly anodic potentials, indicating that the reaction generally becomes more favourable as the quantity of platinum on the surface increases. The reduction current gradually increased with an increasing deposition time up to 5 s. The same peak current (approximately 2.5 μA; background subtracted) is seen for times greater than or equal to 5 s (10 and 20 s showed the same currents and similar shape to 5 s). Optimum deposition parameters of −1.0 V for 5 s were therefore chosen to give low background currents with good oxygen sensitivity, which could be quantitatively described.

### Example 1

### pBDD Macro Disk Electrode Characterisation

The electrochemical behaviour of the in-house prepared 1 mm diameter disk pBDD macroelectrodes was verified. FIG. 3 shows typical cyclic voltammograms (CVs) recorded for the reduction of the simple outer sphere electron transfer redox species, Ru(NH₃)₆³⁺ at concentrations of (a) 1 mM and (b) 10 mM, in 0.1 M KCl recorded at scan rates of 10, 20, 50 and 100 mV s⁻¹. The peak to peak potential separations, ΔEₚ, are given in Table 1, and show values very close to reversibility³² (55.7 mV for one electron transfer at 294 K) for both concentrations. The results at 10 mM Ru(NH₃)₆³⁺ are particularly unexpected in view of previous results in Goeting et al. which show distorted voltammograms even at 4 mM due to electrode resistance issues.³³

TABLE 1
Peak separations for 1 mm diameter BDD macrodisc electrodes

| | | |
|---|---|---|
| Scan rate/mV | 1 mM | 10 mM |

| s−1 | iₚ^{red}/μA | ΔEₚ/mV | iₚ^{red}/μA | ΔEₚ/mV |
|---|---|---|---|---|
| 10 | −0.61 | 67 | −6.13 | 72 |
| 20 | −0.82 | 67 | −9.02 | 72 |
| 50 | −1.26 | 67 | −13.5 | 73 |
| 100 | −1.95 | 67 | −17.1 | 74 |

Previous studies at this latter concentration,²⁸ using larger area pBDD electrodes (5×5 mm), showed distorted voltammograms (e.g. ΔEₚ˜162 mV at 100 mV s⁻¹), which was thought to be due to either resistance effects in the diamond film or the effect of finite charge carriers in the depletion layer (effecting k°, the electron transfer rate constant). The results obtained here (i.e. close to reversibility), using the same quality diamond, but with a much smaller area (hence lower currents) suggests that resistance effects dominated in the previous study. It is important to note that the cutting process may deposit amorphous carbon on the sides of the diamond cylinder, however, prior to electrical connection, the diamond is thoroughly cleaned in acid at high temperature and the cylinder is sealed in glass, which is then polished to expose the diamond surface such effects are thus considered to be negligible. The peak currents, in FIG. 3, were as expected based on linear diffusion and the Randles-Sevcik equation, assuming a value of 8.8×10⁻⁶ cm² s⁻¹ for the diffusion coefficient, D, of Ru(NH₃)₆²⁺.³⁴

FIG. 4 shows CVs recorded at 100 mV s⁻¹ with (a) a 1 mm diameter pBDD macrodisc electrode and (b) a 3 mm platinum macrodisc electrode in deaereated (nitrogen saturated: black line; no peak at around −0.175 V) and aerated (grey line; peak at around −0.175 V) 0.1 M KNO₃ solutions. The currents have been normalised by electrode area and are presented as current density to enable comparison between the two electrodes. FIG. 4 (black lines) clearly shows the reduced background current for pBDD compared with platinum. and the extended solvent window. In this instance, background currents are due to several factors including surface oxidation/reduction processes, hydrogen adsorption/desorption, double layer charging, solvent decomposition etc,³⁵ which are reduced at the pBDD surface over the potential range shown. The data presented also confirm that the laser cutting process had no detrimental effect on the diamond quality, through the introduction of graphitic impurities.

These would act to narrow the solvent window and as the inset to FIG. 4 shows similar data is recorded with pBDD not subject to a laser cutting process.

In aerated solution (grey lines), a reduction peak can be clearly identified at the platinum electrode occurring ˜−0.175 V vs. SCE. This is in the potential range for oxygen reduction on Pt¹² and is of the magnitude expected for a 4 electron transfer process. Interestingly on pBDD, the CV for aerated solution appears almost featureless and there is no discernable wave for oxygen reduction, in the potential range investigated, consistent with prior work.²⁷

### Example 2

### Platinum Nanoparticle Characterisation

FE-SEM and AFM were used to characterise the surface of the platinum nanoparticle-modified BDD electrode for the deposition parameters stated. FIGS. 6(a) and (b) show low and high-resolution images, respectively of the platinum nanoparticle-modified pBDD electrode using FE-SEM; it is possible to resolve both the underlying grain structure of the pBDD and the platinum particle distribution. The platinum nanoparticles can be seen to deposit randomly over the pBDD surface with no evidence of preferential deposition at grain boundaries. Grain boundaries have been suggested as the main active sites on other diamond samples.³⁶ However, pBBD, FE-SEM does indicate a difference in particle density between grains of varying conductance.²⁸ The less conducting grains appear lighter in FE-SEM images due to more associated charging.²⁸ In these regions the platinum nanoparticle density appears lower than the neighbouring higher conductance regions. This is seen more clearly in the higher magnification image in FIG. 6(b). Due to static charging effects it is not possible to obtain quantitative information on particle size with FE-SEM, thus the morphology of the platinum nanoparticle was further investigated using tapping-mode AFM.

FIG. 7(a) shows a 1 μm×1 μm tapping mode AFM image of electrochemically deposited platinum nanoparticles (−1.0 V for 5 s) in an area where there are two different grains. The grain boundary is indicated by the dashed line in FIG. 7(a). As can be seen from the line profile, there is only a slight change in height at the grain boundary of ca. 2 nm as the sample has been polished to yield a surface roughness of ca. 1-2 nm. The small step height is because differently orientated grains polish at different rates.³⁷ There is evidently no preferential particle deposition at the boundary between the two different grains in the images shown, but there is a clear difference in the density of particles on a grain.

FIG. 7(b) was recorded at higher resolution (0.5 μm×0.5 μm) in the area just to the right of the grain boundary in FIG. 7(a) and shows a particle surface density of ca 130 Pt NPs μm⁻² with the associated size distribution shown (mean nanoparticle height of ca. 3 nm). FIG. 7(c) shows a 1 μm×1 μm scan in the area to the left of the grain boundary in FIG. 7(a). Here the particle distribution is higher ca. 340 platinum nanoparticles μm ⁻², with the height distribution shown in the inset (mean nanoparticle height of 1 nm). From the FE-SEM data and our previous studies of electrodeposited metals on pBDD³⁸ the high density, smaller average particle height corresponds to the lower conductivity grains. Changes in the conductivity of the grains are linked to variations in boron uptake at different orientation grains. We highlighted in detail previously that typically two types of characteristic conductivities are observed on E6 prepared pBDD surfaces.³⁸ It is, however, important to note that although electro-deposition is non-uniform across the surface, the close spacing of the platinum particles (typically 20 nm high density regions and 50 nm in the low density regions) means that on the timescale of typical measurements there will be considerable diffusional overlap between neighbouring particles, so that the electrodes behaves as a conventional planar electrode as evident from FIG. 5 above and further work reported below.

### Example 3

### Dissolved Oxygen Detection in Nitrate Media

The sensitivity of the composite electrode to varying dissolved oxygen concentrations, denoted as % oxygen in an oxygen/nitrogen controlled ratio, for different pH conditions (pH 4, 5.5, 7.5 and 10) was investigated. FIG. 8 shows CVs for the reduction of oxygen in 0.1 M KNO₃ and H₂SO₄ (pH 4) at a platinum nanoparticle-modified BDD electrode over the range 0-100% oxygenated solution. A clear oxygen reduction peak was observed at ca. −0.195 V, which showed an excellent response to the effect of varying the dissolved oxygen concentration. A plot of peak currents (corrected by the response with 0% O₂) versus dissolved oxygen concentration is shown inset. The dissolved oxygen concentrations were calculated using Henry's law assuming an ideal dilute solution and a Henry's law constant for oxygen of 769.2 atom/(mol dm⁻³).

Chronoamperometry was employed to verify the number of electrons in the oxygen reduction process at the platinum nanoparticle-modified BDD electrodes over the pH range 4-10, and to provide an alternative means of quantitative oxygen concentration analysis. FIG. 9(a) shows chronoamperometric curves recorded for the reduction of oxygen in 0.1 M KNO₃ and HCl (pH 4), at various oxygen concentrations (in the range 0-100%). The curves were obtained by stepping the potential from 0.2 V to −0.5 V. The current scale shown emphasizes the variation in the long time current as a function of oxygen concentration. The inset to FIG. 9(a) shows the full scale data. The current plotted against t^{-1/2} yielded a straight line as predicted by the Cottrell equation:

$$I ( t ) = \frac{{nFAD}_{o}^{1 / 2} {C}_{o}^{*}}{{π}^{1 / 2} {t}^{1 / 2}}$$

where n is the number of transferred electrons, F is the Faraday constant, A is the area of the BDD electrode, Dₒ and Cₒ are the diffusion coefficient and concentration of oxygen. This is shown in FIG. 9(b) for a 30% oxygen flow in solutions of pH 4, 5.5, 7.5 and 10. This was true for all oxygen concentrations investigated and all pH solution conditions. The chronoamperometric gradients give apparent number of electrons transferred as 3.6, 4.2, 3.8 and 3.7 for pH 4, 5.5, 7.5 and 10 respectively. This is assuming a D for oxygen of 2.28×10⁻⁵ cm² s⁻¹.¹² Cottrellian diffusion assumes linear diffusion which again provides further evidence that on the timescale of these measurements all the diffusion fields of the individual platinum nanoparticles are overlapping. A 4 electron process was found for all solutions investigated in the pH range 4 to 10.

FIG. 10 shows a plot of the gradients from the Cottrellian analyses (corrected by the response with 0% O₂) versus the oxygen concentration, for pH 4 (▪), 5.5 (), 7.5 (▴) and 10 (▾). A linear relationship between the chronoamperometric gradient and concentration of oxygen at the platinum nanoparticle-modified BDD electrode is observed. The long time current (˜>5 s) flowing at the electrode in nitrogen-saturated solution (i.e. 0% oxygen) is ca. 0.1 μA as can be seen from FIG. 9(a) giving a background gradient of −4×10⁻⁷. Assuming that this gradient value represents a limit of detection, using this quiescent solution technique, it should be possible to detect dissolved oxygen concentrations as low as ca 2 ppb (This was calculated using the gradient value which is equal to nFAD^{1/2}Cπ^{-1/2} according to the Cottrell equation, and therefore a concentration in mol cm⁻³ which was converted to ppb) under a wide range of pH conditions.

Finally, the stability of the platinum nanoparticles electrodeposited on the BDD surface and the reproducibility of the sensor over a twelve hour time period was examined. Chronoamperometric measurements were taken every hour for 12 hours in a 0.1 M KNO₃ solution of pH 5.5 with oxygen at 40%. FIG. 11 shows the chronoamperometric gradient, as well as the current at 3 s for the 12 readings. For all twelve measurements the chronoamperometric gradient was in the range 3.59 μA-3.79 μA which according to the data in FIG. 10, represented a variation of 30 μM of oxygen in solution. This data shows significant promise for the long time use of Platinum nanoparticles electrochemically deposited onto pBDD electrodes.

### Example 4

### Dissolved Oxygen Detection in Chloride Media

The sensitivity of the composite electrode to varying dissolved oxygen concentrations in the presence of chloride ions was also investigated. Different ratios of oxygen to nitrogen were flowed into a 0.1 M KCl solution for ca. 30 mins The electrode was removed from solution in between readings. Chronoamperometric curves were recorded by stepping the potential from 0.0 V (where no redox processes occurred) to −0.7 V (where oxygen reduction is transport-controlled) for a time period of 10 s. FIG. 12 shows the Cottrell gradient plotted against the dissolved oxygen concentration. A linear relationship is observed, as with KNO₃, indicating that the current response in chloride media is indeed linear with dissolved oxygen concentration. Interestingly the Cottrell gradient is less than that recorded in the presence of KNO₃, which possibly points at a switch in the mechanism for oxygen reduction.

The reproducibility of the response of the electrode in 0.1 M KCl was also investigated. Chronoamperometric measurements were taken every hour over a twelve hour period where the electrode was left immersed in the solution, under aerated conditions. As can be seen from FIG. 13, all the Cottrell gradients over the twelve hours were in the range −2.51 to −2.64 μA s1/2, representing a variation of 20 μM of oxygen in solution. These results indicate better stability of the BDD electrode under chloride conditions than in the presence of nitrate.

### Example 5

### Electrode Stability

Platinum-modified boron-doped diamond disc electrodes were fabricated, as described above, in order to study their long term dissolved oxygen sensing capabilities. An electrode was kept in 0.1 M KNO₃ under aerated conditions for two weeks with chronoamperometric transients recorded once a day. The results are plotted in FIG. 14 (Cotrellian gradient versus time in days).

For these 14 measurements, the Cottrell gradient was in the range −1.47 μA s1/2 to −1.75 μAs1/2 (representing a variation of 42 μM) and showing that the electrode is stable over a significant period of time.

### Example 6

### Oxygen Sensing in the Presences of a Nafion Film

The composite electrode was coated with 10 and 50 layers of Nafion, using Langmuir Blodgett methodologies, to form a film. CV's for the reduction of oxygen for 10 layers (FIGS. 15(b)) and 50 layers (FIG. 15(c)) in 0.1 M KNO₃ are shown. FIG. 15(a) is a comparative figure showing the voltammetric response to oxygen in the absence of the Nafion film.

Typically the conditions in these tests were standard aerated conditions (i.e. natural oxygen concentration in water) unless otherwise stated.

A clear reduction peak is observed at c.a −0.43 V in each figure, illustrating the continued ability of the coated electrode to detect oxygen.

FIG. 15(b) illustrates stability of the electrode to 3 sweeps spaced by 30 seconds, Sweep 1 provides a peak current of around −3.7 μA; Sweep 2 a peak current of around −3.3 μA; and Sweep 3 a peak current of around −2.95 μA.

In addition, FIG. 15(c) illustrates the ability of the electrode to detect oxygen over a range of concentrations. The sweep in which a reduction peak is absent represents the control sweep where no oxygen is present in the gas flow. The sweep of peak current around −7 μA represents a 50% oxygen to nitrogen ratio and the sweep of peak current around −8.2 μA represents a 100% oxygen flow.

It should be appreciated that the metal nanoparticle-modified BDD and methods of the invention are capable of being incorporated in the form of a variety of embodiments, only a few of which have been illustrated and described above.
¹ Riedo B., Dietler G., Enea O., Thin Solid Films, 2005, 488, 82.
². Stetter, J. R.; Li, J. Chem. Rev. 2008, 108, 352 and reference therein.
³ Ramamoorthy, R.; Dutta, P. K.; Akbar, S. A. J. Mater. Sci. 2003, 38, 4271.
⁴. Hichman, M. L. “The measurement of dissolved oxygen”. John Wiley, New York, 1978
^{5.} Knake, R.; Jacquinot, P.; Hodgson, A. W. E.; Houser, P. C. Anal. Chim. Acta. 2005, 549, 1.
⁶ Sonsa, M.; Denuault, G.; Pascal, R. W.; Preien, R. D. ; Mowlwm, M.; Sensors and Actuators B. 2007, 123, 344.
⁷ Yeager, E. J. Molecular Catalysis. 1986, 38, 5.
⁸. Wroblowa, H. S.; Pan, Y. C.; Razumney, G. J. Electroanal. Chem. 1976, 69, 195.
⁹. Zurilla, R. W.; Sen, R. K.; Yeager, E. J. Electrochem. Soc. 1978, 125, 1103.
¹⁰. Damjanovic, A.; Greenshaw, M. A.; Bockris, J. O'M. J. Electrochem. Soc. 1967, 114, 1107.
¹¹ Yeager E. Electrochimica Acta 1984, 29, 1527.
¹² Pletcher, D.; Sotiropoulos, S. J. Electroanal. Chem., 1993, 356, 109.
¹³ Pletcher, D.; Sotiropoulos, S. J. Chem. Soc. Faraday Trans., 1995. 91. 457.
¹⁴ Birkin, P. R.; Elliott, J. M.; Watson, Y. E. Chem. Commun., 2000, 1693.
¹⁵ Pleskov, Y. V. Russ. J. Electrochem. 2002, 38, 1275.
¹⁶ Xu, J. S.; Granger, M. C.; Chen, Q. Y.; Strojek, J. W.; Lister, T. E.; Swain, G. M. Anal. Chem. 1997, 69, A591.
¹⁷ Compton, R. G.; Foord, J. S.; Marken, F. Electroanalysis 2003, 15, 1349.
¹⁸ Ramesham, R.; Rose, M. F. Diamond and Related Mater 1997, 6, 17.
¹⁹ Yano, T., Tryk, D. A., Hashimoto, K., Fujishma, A., J. Electrochem. 1998, 145, 1870.
²⁰ Yano, T., Tryk, D. A., Hashimoto, K., Fujishma, A., J. Electrochem. Soc. 1999, 146. 1081.
²¹ Tian, R., Zhi, J., Electrochem. Commun. 2007, 9, 1120.
²² Zhang, Y., Asahina, S., Yoshihara, S., Shirakashi, T., Electrochim. Acta, 2003, 48, 741.
²³ Sarapuu, A., Helstein, K., Schiffrin, D. J., Tammeveski, K., Electrochem. Sol. Stat. Lett. 2005, 8, E30.
²⁴ Kruusma, J.; Banks, C. E.; Compton, R. G.; Anal. Bioanal. Chem. 2004, 379, 700-706.
²⁵ Yagi, I., Ishida, T., Uosaki, K., Electrochem. Commun. 2004, 6, 773
²⁶ Szunertise, S.; Manesse, M>; Actis, P.; Marcus, B.; Denuault, G.; Jama, C.; Boukherrob, R. Electrochem. Solid St. Lett. 2007, 10, G43
²⁷ Wang, J.; Swain, G. M. J. Electrochem. Soc. 2003, 150, E24.
²⁸ Wilson, N. R.; Clewes, S. L.; Newton, M. E.; Unwin, P. R.; Macpherson, J. V. J. Phys. Chem. B. 2006, 110, 5639-5646.
²⁹ Tachiban, T.; Williams, B. E.; Glass, J. T. Phys. Rev . B. 1992, 45, 11975.
³⁰ Wightman, R. M.; Wipf, D. O. In Electroanalytical Chemistry; Bard, A. J., Ed.; Marcel Dekker: New York, 1989; Vol. 15, p 267.
³¹ Pletcher, D.; Sotiropoulos, S. J. Chem. Soc. Faraday Trans. 1994, 90, 3663.
³² Bard, A. J.; Faulkner, L. R. Electrochemical Methods; John Wiley: New York, 1980; p 230.
³³ Goeting, C. H.; Jones, F.; Foord, J. S.; Eklund, J. C.; Marken, F.; Compton, R. G.; Chalker, P. R.; Johnston, C. J. Electroanal. Chem. 1998, 442, 207.
³⁴ Macpherson, J. V.; O'Hare, D.; Unwin, P. R.; Winlove, P. Biophys. Journal. 1997, 73, 2771.
³⁵ Bard, A. J.; Faulkner, L. R. Electrochemical Methods; John Wiley: New York, 1980; p 12.
³⁶ Holt, K. B.; Bard, A. J.; Show, Y.; Swain, G. M.; J. Phys. Chem. B. 2004, 108, 15117.
³⁷ El-Dasher, B. S.; Gray. J. J.; Tringe, J. W.; Biener, J.; Hamza, A V ; Wild, C.; Worner, E.; Koidl, P. Appl. Phys. Lett. 2006, 88, 241915.
³⁸ Colley, A. L.; Williams, C. G.; Johansson, U. D.; Newton, M. E.; Unwin,P. R.; Wilson, N. R.; Macpherson, J. V. Anal. Chem. 2006, 78, 2539.

1-53. (canceled)

54. A method for preparing metal nanoparticle-modified boron-doped acid treating at least part of a front surface of at least one boron-doped diamond to oxygenate the acid treated part of the boron-doped diamond;
depositing metal nanoparticles onto at least one surface of a boron-doped diamond;
wherein the acid treating occurs in a step prior to a step of depositing the metal nanoparticles onto the front surface of the boron-doped diamond; and
wherein deposition of metal nanoparticles is chronoamperometric.

55. The method of claim 54 wherein the chronoamperometric deposition occurs at a potential in the range of about 0.8 to about 1.0 V relative to a saturated calomel electrode.

56. The method of claim 54 wherein the chronoamperometric deposition occurs over a period in the range selected from the group consisting of 0.1 to 10 seconds and 5 to 10 seconds.

57. The method of claim 55 wherein the chronoamperometric deposition occurs over a period in the range selected from the group consisting of about 0.1 to about 10 seconds and about 5 to about 10 seconds.

58. The method of claim 54, wherein the boron-doped diamond is incorporated into a column, wherein the column is prepared using laser cutting and a surface of said column comprises the acid-treated surface.

59. A metal nanoparticle-modified boron-doped diamond prepared according to the method of claim 54, wherein the front surface of the boron-doped diamond has a roughness in a range selected from the group consisting of about 1 nm to about 20 nm and about 1 nm to about 2 nm.

60. A metal nanoparticle-modified boron-doped diamond prepared according to the method of claim 54, wherein the boron-doped diamond is a single crystal diamond.

61. A metal nanoparticle-modified boron-doped diamond according to claim 59 wherein the boron doping concentration of the single crystal is in the range of about 70% to about 100% homogeneous.

62. A metal nanoparticle-modified boron-doped diamond prepared according to the method of claim 55 wherein the metal nanoparticles are about 0.5 nm to about 5 nm in size.

63. A metal nanoparticle-modified boron-doped diamond according to claim 62 comprising boron in a concentration in the range of about 5×1020 to about 1×1019 boron atoms per cm3.

64. A metal nanoparticle-modified boron-doped diamond according to claim 60 wherein a front surface of the single crystal is selected from a face equal to or within ±5° of a face selected from the group consisting of the {100}, {110}, {111}, and {113} faces.

65. A metal nanoparticle-modified boron-doped diamond according to claim 60, wherein at least a portion of the nanoparticle-modified boron-doped diamond is coated with an at least partially gas permeable film comprising a tetrafluoroethylene-perfluoro-3,6-dioxa-4-methyl-7-octenesulfonic acid copolymer.

66. An electrode comprising a metal nanoparticle-modified boron-doped diamond according to claim 60, wherein the electrode is selected from the group consisting of a disc electrode, a microelectrode and a band electrode.

67. A disc electrode according to claim 66 wherein the disc electrode has a diameter in the range of about 100 nm to about 2 mm.

68. A band electrode according to claim 66 wherein the band electrode is substantially rectangular, and wherein each side of the rectangular band electrode is of a length in the range between about 100 nm to about 2 cm.

69. A microelectrode according to claim 66, wherein the microelectrode is approximately 50 μm or less in diameter.

70. An electrode according to claim 66 wherein the metal nanoparticle-modified boron-doped diamond is at least partly insulated with an insulator selected from group consisting of: glass, PTFE, polypropylene, porcelain, polyethylene, PVC, silicone, ethylene tetrafluoroethylene.

71. A method of manufacturing an electrode, the method comprising the steps of:
providing a boron-doped diamond column;
acid-treating at least part of a front surface of the boron-doped diamond column;
insulating the column; and
depositing metal nanoparticles onto the front surface of the column.

72. A method according to claim 71, wherein only the front surface of the column is exposed.

73. A method according to claim 71 comprising the additional step of polishing at least part of the front surface of the column, wherein the polishing occurs prior to acid treating the front surface of the column.

74. An electrode according to claim 71, the electrode operable to detect oxygen in a solution.

75. An electrode according to claim 74 wherein oxygen detection occurs via amperometric or voltammetric detection.
